(19) United States
(12) Patent Application Publication
(10) Pub. No.: US 2017/0126525 A1
(43) Pub. Date: May 4, 2017

(54) SYSTEMS AND METHODS FOR CONTROLLING DEVICES

(71) Applicant: Thington, Inc., San Francisco, CA (US)

(72) Inventors: Thomas Edward Coates, San Francisco, CA (US); Matthew Simon Biddulph, San Francisco, CA (US); Steve Streza, San Francisco, CA (US); Eric Oesterle, Napa, CA (US)

(73) Assignee: Thington, Inc., San Francisco, CA (US)

(21) Appl. No.: 15/342,115

(22) Filed: Nov. 2, 2016

Related U.S. Application Data
(60) Provisional application No. 62/249,419, filed on Nov. 2, 2015.

(51) Int. Cl. H04L 12/26; H04L 29/06; H04L 29/08

(52) U.S. Cl. CPC H04L 43/0817; H04L 67/10; H04L 67/42; H04L 67/02; H04W 4/008

(57) ABSTRACT

A server-based system includes a server that is a centralized Internet of things (IoT) aggregator, broker, and control system, with a concierge function. The system allows any number of IoT devices and user interface devices to be placed on a single network, where the system translates data received from the IoT devices and the user interface devices into a single data standard, having a standardized language for each of the IoT devices and the user interface devices. This allows all of these devices to communicate and react to one another in an open fashion, and any user is afforded an opportunity to react with various things, such as public objects, as the user moves about to different places around the world. Additionally, a user may add another user to a Guestlist for a place, thus giving that other user limited control over the IoT devices in that place.

### CROSS REFERENCE TO RELATED APPLICATIONS

This application claims the benefit of and priority to U.S. Provisional Patent Application No. 62/249,419, filed on Nov. 2, 2015, which is hereby incorporated by reference in its entirety.

### TECHNICAL FIELD

The disclosure relates generally to computer-based systems for controlling and relaying data to users and allowing users to control various devices.

### BACKGROUND

Network communication and connectivity is becoming commonplace in an increasing number of everyday devices. For instance, thermostats, light switches, audio-visual equipment, appliances, weather stations, and security systems often come equipped for network communication. As such, users are able to utilize their smartphones, tablets, or other computing devices to receive information from and/or control these devices. As just a few examples, a user can turn on lights in their home or change the temperature on the thermostat in their office using their smartphone.

### SUMMARY

In one aspect of the disclosure, a server-based system is configured to provide a centralized user interface layer that receives updates from objects resident within specific places, and in the wider world, as social-media style real-time distributed messages, with data payloads. Arbitrary “triggers” may be set by users of the system, where a rules engine is configured to listen to incoming updates.

This allows any number of Internet of things (IoT) devices, and any number of user interface devices to be connected to a single network as a “commons”. The system is configured to convert, or otherwise translate, data received from any one or more of the various IoT devices and the various user interface devices into a single data standard, i.e., a “core vocabulary”. As such, the system's commons is configured to take data from multiple sources in multiple formats in multiple ways and converts all of the data to a standard. The single data standard allows all of the user interface devices to communicate and react to one another in an open fashion. The open communication, along with the translation of the various data into the common language, allows any user to walk throughout the world, while being afforded an opportunity to react with the various things, afforded an opportunity to react with things they own, things shared with them by their friends, or in the form of public objects.

The system includes a server having a processor and a memory. The server is configured to be in networked communication with each of the various IoT devices, each of the various user interface devices, via the network.

The server is configured to translate data or application programming interface (APIs) received from the various devices into a common, but extensible, standard. A microservices layer may receive and translate the APIs received from their distinctive vocabularies into a core vocabulary.

In another aspect of the disclosure, the system may be configured such that the devices are potentially available to anyone, when the user has been granted the relevant permissions. This allows users to share access to devices that might otherwise be fully private, with friends or fully shared with the public. As such, not only may a normal user be able to walk through the world and be afforded things as the user need them, but all users may share information with one another in the form of public objects and create arbitrary relationships between any two (or more) devices that the users see in the system. Therefore, the commons may be configured such that any information that you choose to share is usable by anyone.

In another aspect of the disclosure, the system includes a social layer includes the ability of a user to add someone else to a “Guestlist” for a place, thus providing the other person with limited control over that specific place. The system is configured to prompt someone to add a friend, as identified via social media, to the Guestlist, when that friend is geographically near. A person may be invited, via email and the like, with all of the information that person needs to find the place, e.g., maps, and the like. People who arrive at the place may be greeted with a specific message that explains the house rules, the WiFi password, and/or the like.

In yet another aspect of the disclosure, the system provides a concierge feature. In the concierge function, the concierge may lead the user through a conversational interface, and then record criteria and responses for the user on their behalf, in the real-time rules engine.

The above features and advantages, and other features and advantages, of the present invention are readily apparent from the following detailed description of some of the best modes and other embodiments for carrying out the invention, as defined in the appended claims, when taken in connection with the accompanying drawings.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a schematic block diagram representing a system for interfacing with various devices according to one exemplary embodiment;

FIG. 2 is a screen presented on a user interface device showing various private IoT devices according to one exemplary embodiment;

FIG. 3 is a screen presented on the user interface device showing various users and their different permissions for private IoT devices in a particular place, according to one exemplary embodiment;

FIG. 4 is a screen presented on the user interface device showing a plurality of private IoT devices and their operation state according to one exemplary embodiment;

FIG. 5 is a screen presented on the user interface device showing detailed operational data for one private IoT device according to one exemplary embodiment; and

FIG. 6 is a screen presented on the user interface device showing a timeline including operational data for a plurality of IoT devices according to one exemplary embodiment.

### DETAILED DESCRIPTION

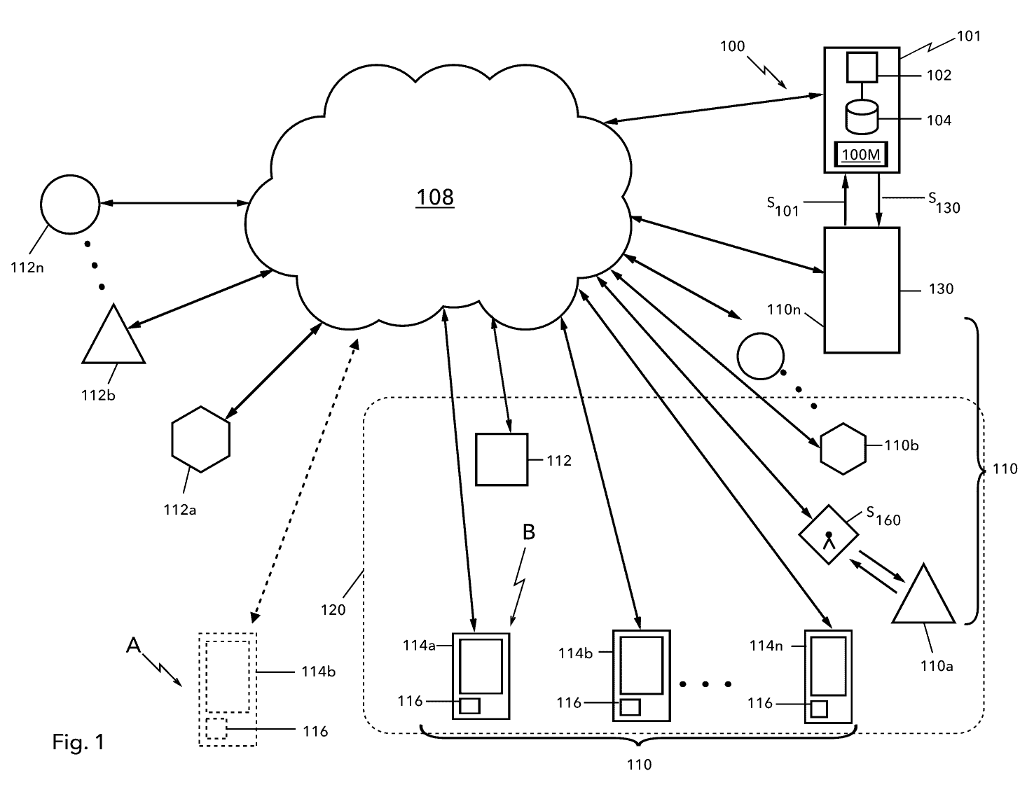

Referring to the Figures, wherein like numerals indicate like parts throughout the several views, a server-based system 100 is shown in FIG. 1 that is configured to allow any number of Internet of things (IoT) devices 110a-110n, 112a-112n (also collectively referred to as IoT devices 110, 112) and user interface devices 114a-114 (also collectively referred to as user interface devices 114) to be placed on a single network 108, where the system 100 converts or otherwise translates the data received from the various IoT devices 110, 112 and the various user interface devices 114 into a single data standard, i.e., a “core vocabulary,” that may be a standardized language for the server 101, as explained in more detail below. The single data standard provides a common language for all of the IoT devices 110, 112 and all of the user interface devices 114 to allow all of these devices 110, 112, 114 to communicate and react to one another in an open fashion, i.e., a “commons”. Therefore, the open communication, along with the translation of the various data into the common language, allows any user, with any one or more of the user interface devices 114, to walk throughout the world, while being afforded an opportunity to react with the various things, afforded an opportunity to react with things they own, things shared with them by their friends, or in the form of public objects. Further, while only a finite number of IoT devices 110, 112 and a finite number of user interface devices 114 are shown in FIG. 1 and/or described herein, it should be appreciated that an unlimited number of IoT devices 110, 112 and an unlimited number of user interface devices 114, spanning the entire globe, may be achieved.

With continuing reference to FIG. 1, the IoT devices 110, 112 and user interface devices 114 include a server 101 having a processor 102 and a memory 104. It should be appreciated that any number of servers 101, each having any number of processors 102 and memory 104, may be distributed about the system 100. The server 101 is configured to be in networked communication with various IoT devices 110, 112, various user interface devices 114, via the network 108. The network 108 may be the system of interconnected networks known commonly as the Internet, a local area network (LAN), a wide area network (WAN), and the like. Further, it should be appreciated that the network 108 may utilize one or more switches, routers, hubs, Wi-Fi access points, etc., and may operate utilizing hardwired and/or wireless techniques. However, for purposes of simplicity, the various hardware devices to provide this communication functionality are not shown.

A second server 130, may also be in networked communication with the server 101, the IoT devices 110, 112, and the user interface devices 114. It should be appreciated that while only a single second server 130 is shown and described, any number of second servers 130 are contemplated.

The server 101 translates data or APIs received from the various devices 110, 112, 114 into a common, but extensible, standard. More specifically, a layer (currently known as a microservices layer) takes the APIs from these various devices 110, 112, 114, and standardizes them, translating the APIs from their distinctive vocabularies into a core vocabulary. Further, for types of information where a standard does not exist in the core of the server 101, this data may still be saved as arbitrary data, in a name spaced way, for reference at a later time.

For illustrative purposes, various thermostats may produce similar data, but in different formats. The microservices layer is configured to translate the differing formats into a common format that the server 101 is programmed to manage.

By way of a non-limiting example, the data would be translated as follows:

core:current-indoor-relative-humidity=55<--reported relative humidity in percentage

core:current-indoor-temperature-in-C=34<--current temperature in Celsius

Whereas other data supplied by an individual thermostat might be very specific to the thermostat device, at which point that data would be stored as arbitrary data in the server 101, against that update. For example, the data may be stored as follows:

nest:has-leaf=yes<--is displaying the leaf symbol on a Nest thermostat.

Since the core vocabulary is common, the server 101 would be configured to understand what a “thermostat” is, no matter who makes it, and would be configured to present controls to a user of a user interface device for any thermostat, while also formatting messages to the user interface device from any thermostat. The server 101 may be configured to offer a user all the thermostats, or all the lights, or only color changing lights in rule-making or in remote controls, as appropriate, regardless of the manufacturer of the thermostat.

Data packets or APIs may be continually or periodically received by the server 101, from the various devices 110, 112, 114. The data packets are distributed across the network 108 in real-time, for any device 110, 112, 114 in need. The data packets of data from the device are then translated into a real-time-messaging format and distributed as messages to devices 110, 112, 114 needing the data packets, via a real-time messaging bus.

Therefore, regardless of how the data packets entered the server 101 the data packets will subsequently be distributed, in real-time, by the server 101 to all of the required devices 110, 112, 114 in much the same way, i.e., in fractions of a second to any part of the system 100 that needs to receive that data. Therefore, various parts of the system 100 may register for updates from one or more of the other devices, and will be sent them immediately they are brought in via the micro services layer.

The system 100 may be configured such that messages are distributed via a timeline appearing on a user's user interface device 110, 112, e.g., mobile phone. Once visible to the user, the user may ‘add’ a thermostat to a user account, and subsequently when an update like this comes in from Nest, the message would be (1) translated into the Core language; (2) turned into a new message format; (3) distributed to the device 110, 112, 114 via the messaging bus, where the data may be presented in a textual form, via a formatting engine and/or in an update to a remote control of the device.

Each type of device 110, 112, 114 may include a number of human readable ‘script templates’ that take important information from all of these devices 110, 112, 114, and present that information to users in a human readable way to users, via their user interface. These updates are published as a stream, in real-time, on the user interface device 114. The published stream allowed the user to go back and look at the history of the device, as well as in a user's main ‘stream’, where the user has the capability to see the most recent updates from all the devices 110, 112 and systems the user is interested in. However, since the information being presented on the user interface device 114 is fundamentally data packets, rules can also be set up within the server 101 to run against these data packets, as explained in more detail below.

Since the devices 110, 112, 114 are in networked communication on the server 108 as one “commons”, as described above, any of the devices 110, 112, 114 can be seen by any other device 110, 112, 114 when permissions have been granted to do so. Further, any device may be configured to be actuated based on a change in any other device and/or by a user's action.

Once a device 110, 112, 114 is registered with the server 101, and its data inputs and data outputs have been rationalized to the core vocabulary, the device 110, 112, 114 becomes available to be seen by any other device 110, 112, 114 with the permissions to do so, while using the core vocabulary. This means that the registered and available device 110, 112, 114 works with the server's 101 rules and/or may be configured to have arbitrary rules built against that device 110, 112, 114, via a rules engine within the server 101.

Any user may build or create a rule between any one or more devices 110, 112, 114 that user's device 114 can view see information from, and any other device(s) 110, 112 that can be actuate. The real-time rules engine will be explained in more detail below.

By default, however, most devices 110, 112 are private, i.e., owned by one or more users, and only those users that have ownership of a particular device 110, 112 can see that private device 110, 112, and set up rules that affect the private device 110, 112. Those users may also share with other owners, or share via a “guestlist”, which may be dynamic, meaning that guestlist can be easily changed centrally at any time, via various criteria.

As a user walks around the world as a guest in people's houses, the devices 110, 112 that user sees, or are not able to see, on their user interface device 114, may be configured to change, as a function of that user's location. Similarly a user (via the server 101) may make a device 110, 112 they own ‘public’, meaning anyone can see the device 110, 112, follow the device 110, 112, and make things react to the device 110, 112. Therefore, any device 110, 112, 114 can react to any other devices in the system, which is managed via the real-time rules engine.

Criteria may be registered against the real-time rules engine by users and/or by the system 100. By way of a non-limiting example, the server 101 they may watch out for a new thermostat to report out data that the environment has gone above a particular relative humidity and also that the temperature from a local weather station is reporting that it is over 90° F. outside. The real-time rules engine may be configure such that under those circumstances, a dehumidifier may be instructed by the server 101 to turn on in a location. The real-time rules engine may subsequently watch out for messages distributed by the respective devices 110, 112. As each message is received, the real-time rules engine may will update an internal sense of ‘state’ for the rule asynchronously. For example, if one message comes in that says it is now 92° F. outside, the real-time rules engine will not trigger the response. If that temperature then drops to 89° F., the temperature will still not trigger the response. If, however, the humidity reaches a threshold and then subsequently a temperature reaches 90° F., then the rule within the real-time rules engine will be triggered, where a new message will then be sent out to a humidifier, indicating the humidifier should turn on, which will result in a message being sent back into the a messaging infrastructure within the server 101 that explains or indicates that the humidifier has turned on and it did so because the initial criteria were met.

In addition to updates regarding the state of a device 110, 112 being transmitted through the system 100, a record of each public or private device 110, 112 or thing in is saved in the system 100 on the server 101. The current ‘state’ of these devices 110, 112 are updated by the incoming data and recorded in the server 101 as a separate record. Second order information, such as average temperatures and average humidity may also be recorded in these records, for quick lookup.

Additionally, because the server 101 knows what devices 110, 112, 114 a particular user has, how these devices work, and the data that is stored about these devices in a common format, the system 100 may be configured to offer rules to a user of the user interface device 114, via a multi-stage process, that guides the user that is much easier than them writing them from scratch. The system 100 may be configured with a concierge function that will lead the user through a conversational interface, and then record criteria and responses for the user on their behalf, in the real-time rules engine.

The user interface device 114 may be any device suitable for communication with the server 101, via the network 108, such as a smart phone, cell phone, mobile phone, tablet, laptop computer, desktop computer, and the like.

The IoT devices 110, 112 may be categorized as private IoT devices 110 and public IoT devices 112. The private IoT devices 110 are selectively recognizable by the user interface device 114, via the networked communication, when granted permission. The private IoT devices 110 may be, but should not be limited to, home accessories, such as lights, ovens, heaters, dishwashers, thermostats, humidifiers, switches, motion sensors, flood sensors, heater-ventilation (“HVAC”) system, television, home entertainment system, security cameras, the like.

As such, in one non-limiting example, the system 100 may only allow the private IoT device 110 to be recognized by the user interface device 114 when certain parameters are met. The parameters may be related to a geographic location of the user interface device 114. By way of a non-limiting example, with continued reference to FIG. 1, when the user interface device 114, indicated by arrow A, is not physically located within a specified region 120, the system 100 does not allow the private IoT device(s) 110 to be recognized or otherwise detected by the user interface device 114. Likewise, when the user interface device 114, indicated by arrow B, is physically located within the specified region 120, the system 100 allows the private IoT device 110 to be recognized or otherwise detected by the user interface device 114. In another non-limiting example, the system 100 allows the private IoT device(s) 110 to be recognized or otherwise detected by the user interface device 114 when the user of a particular interface device 114 is designated by the system 100 as an “owner”. The user may be designated by the system 100 as being an owner by virtue of having added the particular private IoT device 110 to the system 100. Likewise, the “owner” of a particular private IoT device 110 may designate another user as also being an owner of the private IoT device 110.

Conversely, the public IoT devices 112 are those devices that are always recognizable by any user interface device 114, regardless of the location of the user interface device 114. Examples of public IoT devices 112 may include bike hire stations, MUNI stations, weather sensors, air quality sensor, water level sensor, drawbridge state sensor, humidity sensor, vending machine, transit stop, and the like.

As already described previously, the system 100 is configured to aggregate, broker, and control the various IoT devices 110, 112 in communication with the network. While the various IoT devices 110, 112 may be provided by the same or different manufacturers, where each manufacturer typically provides a distinct application, i.e., application programming interface (API), to control and/or monitor a status of the respective IoT device 110, 112, such aggregation allows control of the various IoT devices 110, 112 from the single user interface device. As such, the distinct API must be used to access and control the IoT device(s) 110, 112 for the respective manufacturer. Further, when allowing users to control and/or monitor various IoT devices 110, 112, located in a single location, e.g., within the same Wi-Fi network, radio network, and the like, the APIs may not be capable of recognizing user preferences relating to the IoT devices 110, 112. More specifically, the individual APIs may not be capable of recognizing that one user may want the IoT device(s) 110, 112 to respond different from how another user may want the IoT device(s) 110, 112 to respond. The system 100 allows all of the IoT devices 110, 112 connected to the network 108 to be controlled from a single user interface device 114, via the User account.

Referring again to the system 100 shown in FIG. 1, the processor 102 executes instructions, i.e., runs a program, performs calculations, moves data, and/or otherwise manipulates data. The processor 102 may be implemented with a microprocessor, a microcontroller, an application specific integrated circuit (ASIC), and/or any other suitable devices. The memory 104 stores data, i.e., information, as described in greater detail below. The memory 104 may be implemented with random access memory (“RAM”), read only memory (“ROM”), flash memory, hard disk drives, floppy disk drives, optical disc drives, magnetic tape, and/or any other suitable devices. The memory 104 is in communication with the processor 102 such that data may be transferred to and from the memory 104. Furthermore, the memory 104 may be integrated as part of the processor 102. The data stored in the memory 104 may be organized and/or otherwise implemented in a database (not separately shown). Further, the data associated with each IoT device 110, 112 in networked communication with the server 101 may be stored in the database. That is, the database may include a record regarding whether each IoT device 110, 112 is a private IoT device 110 or a public IoT device 112.

The server 101 may routinely query and/or receive data from at least one of the IoT devices 110, 112. As such, the server 101 may store the current state of each IOT devices 110, 112 and/or other data received from each IoT devices 110, 112 in the memory 104 for later use, as described in greater detail below.

The user interface device 114 may be implemented as a smart phone, cell phone, mobile phone, tablet computer, laptop computer, desktop computer, etc.

The user interface device 114 may include at least one output mechanism (not numbered), at least one input mechanism (not numbered), a processor (not shown), and a memory (not shown). The output mechanism may be implemented with a display, a plurality of lights, a speaker, a vibration apparatus, and/or any other suitable instrument. The at least one input mechanism may be implemented with, e.g., a touch screen, one or more pushbuttons, one or more switches, a mouse, a touch pad, a keyboard, a microphone, and/or any other suitable instrument. The user interface devices 114 may receive input at the input mechanism from a user regarding and desired operation of one or more of the IoT devices 110, 112, as described in greater detail below.

The processor of the user interface device 114 is capable of executing instructions, i.e., running a program, performing calculations, moving data, and/or otherwise manipulating data. The processor may be implemented with a microprocessor, a microcontroller, an application specific integrated circuit (ASIC), and/or any other suitable devices as appreciated by those skilled in the art. The memory may be implemented with RAM, ROM, flash memory, hard disk drives, floppy disk drives, optical disc drives, magnetic tape, and/or any other suitable devices as appreciated by those skilled in the art. The memory is in communication with the processor such that data may be transferred thereto and therefrom. Furthermore, the memory may be integrated as part of the processor within the user interface device 114.

With continued reference to FIG. 1, each user interface device 114 may include a location sensor 116 capable of providing a geographic location of the user interface device 114. The location sensor may be, for example, a global positioning system (“GPS”) receiver (not separately numbered). However, it should be appreciated that the geographic location of the user interface device 114 may be achieved by other techniques, e.g., a location of the wireless router, triangulation based on cellular network signals, manual input of location coordinates, etc. The geographic location of the user interface device 114 may be utilized, as described below, to control operation and/or receive status information of at least one IoT device 110, 112. It should be appreciated that some user interface devices 114 may not include a location sensor 116.

In operation, a user interfaces with the system 100 via the user interface device 114. In one embodiment, the user may interface with the system 100 via a web browser on the user interface device 114. In another embodiment, the user may access an executable application, i.e., an “app”, running on the user interface device 114.

In order for the user interface device 114 to interface with the system 100, the user may initially create a user account, where information related to the user account is subsequently stored in the database of the system 100. The user information may include, but is not limited to the user's name, phone number, email address(es), physical address(es), preferences, and other identifying information, as described in greater detail below.

In one embodiment, the user may choose to obtain the user information from one or more of the user's social media accounts. For example, the user account may be selectively linked to the user's social media account on Facebook, Twitter, Google, Instagram, LinkedIn, Snapchat, and the like. As such, the server 101 obtains information from the social media account(s) including, but not limited to, contacts and/or potential “friends” of the user. The linking of the user account to the user's social media account(s) may occur during the initial setup of the user account, or at any other time. In one embodiment, the system 100 also identifies the contacts and/or potential “friends” of the user that have also created a respective user account.

A user may operate the user interface device 114 to locate one or more public IoT devices 112. The public IoT devices 112 may, for example, be shown on a map, displayed on a display screen of the user interface device 114. The user may then select the desired public IoT device(s) 112 from the display screen, where the system 100 may subsequently associate the selected public IoT device 112 with a list, such as a “favorites list”, stored in the memory 104. The system 100 may be configured such that information from the public IoT devices 112, associated with the favorites list, is selectively displayed on the user interface device 114.

The database of the exemplary embodiment may also include various places or locales. The information associated with these places may include a name for each place, a geographical location (e.g., latitude and longitude) for each place, and the user(s) associated with each place. For example, with reference to FIG. 1, the user may be associated with a first place named “Tom's House” and a second place named “Office”.

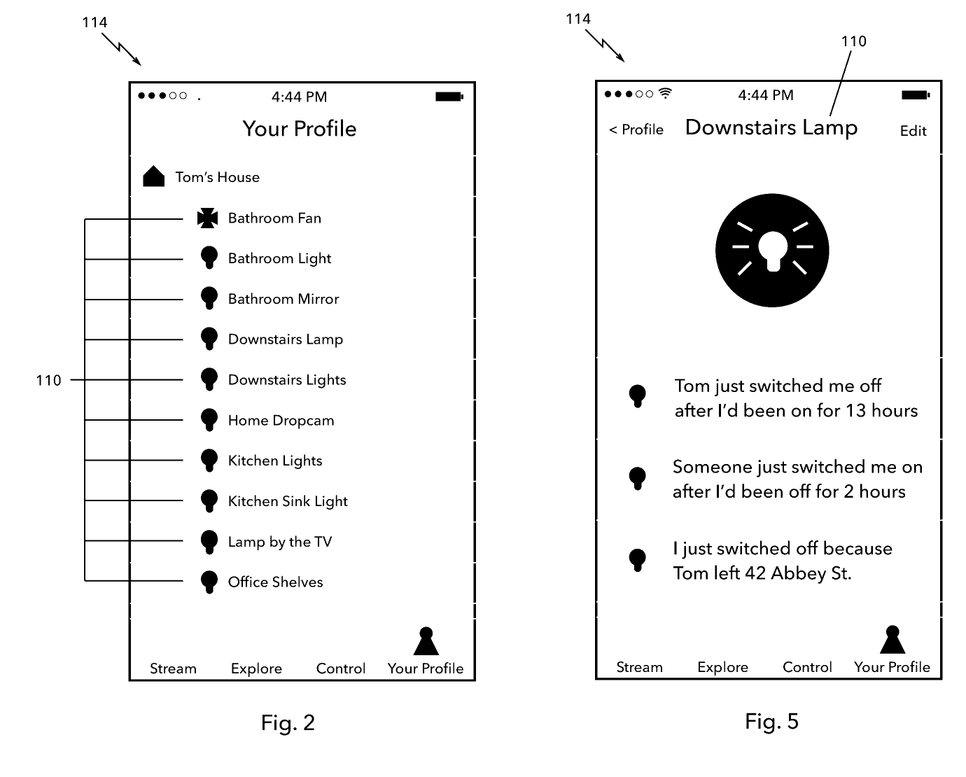

The private IoT devices 110 may be configured and/or otherwise setup prior to being linked with the system 100 over the network 108. For instance, a user may utilize a separate application, e.g., an app provided by the manufacturer of the private IoT device 110, to configure the private IoT device 110 to communicate with the network 108 and/or receive commands from the network 108. However, it should be appreciated that private IoT devices 110 may be linked to the system 100 without being setup beforehand. By way of a non-limiting example, the user may use the user interface device 114 to configure the system 100 to recognize the private IoT device 110. Additionally, the user may add information regarding the private IoT device 110 to the database. This data may include, but is not limited to, names, icons, and which place(s) associated with the private IoT device 110. Referring now to FIG. 2, exemplary naming conventions for a variety of private IoT devices 110 associated with the first place are shown.

The user information may include a first permissions classification and a second permissions classification. The permissions classifications may be utilized in controlling operation of the private IoT devices 110. In the exemplary embodiments, the first and second permissions classification is associated with the private IoT devices 110 of a particular place. That is, the first permissions classification is associated with being an “owner” or having complete control of the private IoT devices 110 in that 120, while the second permissions classification is associated with “guests” having limited control of the private IoT devices 110 in that 120. It should be appreciated that additional permissions classifications may be implemented.

In the exemplary embodiments, the first permissions classification is associated with allowing full control of one or more private IoT devices 110, regardless of the location of the user interface device 114, relative to a place 120 surrounding the private IoT device 110. As such, users having a first permissions classification may utilize the user interface device 114 to turn on lights, turn off a fan, etc., and the like, from any location. Furthermore, with the first permissions classification, a user may exert additional controls over the one or more private IoT devices 110. For instance, a user associated with a first permissions classification of a private IoT device 110 may change the name of the device 110, assemble rules, and/or change the settings of the device 110.

In contrast, the second permissions classification is associated with inhibiting operation of and/or communication with one or more private IoT devices 110 based on the geographic location of the user interface device 114. For example, a user having a second permissions classification may only utilize the user interface device 114 to, e.g., turn off a light, from certain geographic locations. Specifically, in the exemplary embodiments, a region 120 is defined as a geographic area encompassing the geographic locations of one or more of the private IoT devices 112. In one embodiment, the place 120 may be a predefined distance from a router (not shown). In another embodiment, the place 120 may be a predefined distance from each private IoT device 112. Other techniques for defining the place 120 may also be contemplated.

A first user may assign a second user the second permissions classification as it relates to control of the private IoT devices at a particular place. Said another way, if the second user is a “guest” at the home or office (i.e., in the geographic area or place 120) of the first user, then the first user may assign the second permissions classification to the second user when the user is located in the place 120. In the exemplary embodiment, this assignment may be initiated by selecting the second user from a list of users within the IoT account that are known to the first user. These known users may be received from the first user's social network profiles, as mentioned above. Alternatively, the first user may enter an email address of a prospective second user. The system 100 may then, in response, send an email to the second user asking them if they would like to download the application and access the private IoT devices 112.

Once the first user has added the second user to the guest list, the second permissions classification is assigned to the second user, and the corresponding designated private IoT devices 112 become visible and accessible to the second user when the second user enters the place 120. After being assigned the second permissions classification, the second user may, under predetermined conditions, operate private IoT devices 112 while in the associated place 120. For example, the second user having the second permissions classification may turn on or off a light while at the home of the first user. However, this functionality ceases when the second user leaves the place 120. This is ideal for houseguests, office visitors, hotel guest, etc. Further, a user that is considered to be a guest may not be given the ability to delete the devices from the system 100.

It should be appreciated that the system 100 may be implemented with more than the first and second permissions classification described herein. For instance, additional permissions classifications may be implemented to more specifically grant control of certain devices at a place. Further, when associating devices with the various permissions classification, the owner may designate certain private IoT devices 110 as being not available or otherwise recognizable to guests within one or more of the permissions classifications. As such, private IoT devices 110 designated as not being available remain hidden from the guest on their user interface device 114. Such private IoT devices 110 may include locks, an owner's bedroom lights, and the like.

Messages may also be sent by the system 100 to the second user when assigned the second permissions classification. For example, a Wi-Fi password may be sent to the second user once assigned the second permissions classification. These messages may be predetermined and/or setup by the first user.

The system 100 may be configured to inquire with the first user whether a potential second user should be added. For instance, if the second user interface device 114 operating the application is detected in the place 120, and the system 100 believes that second user is a contact or has a social relationship with the first user, then the system 100 may send a message to the first user on the first user interface device asking the first user if the second user should be added, i.e., assigned the second permissions classification for that location. The first user may then reply “yes” or “no”. In response to “yes”, the system 100 assigns the second user classification to the second user accordingly.

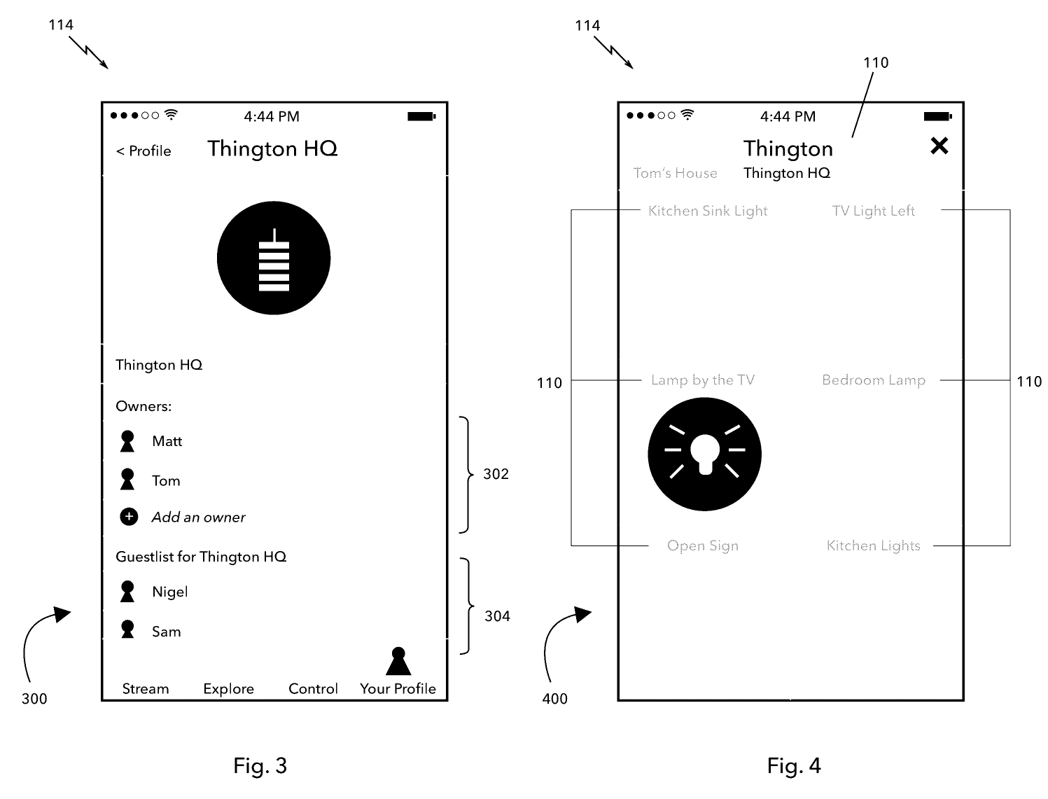

FIG. 3 shows an exemplary screen 300 displayed on the user interface device 114. This screen 300 shows, for a particular place, which users 302 are assigned the first permissions classification and which users 304 are assigned the second permissions classification.

FIG. 4 shows another exemplary screen 400 displayed on the user interface device 114. This screen 400 displays a plurality of private IoT devices 110. This screen 400 displays the state of each private IoT device 110, e.g., on or off. This screen 400 further accepts an input, via a touchscreen interface, to command each private IoT device 110 to operate, i.e., turn on or off. Of course, numerous variations of this screen 400 may be utilized in alternate embodiments. Further, it should be appreciated that other remote control functions of the private IoT devices 110 may be commanded, such as changing the color of a light, changing the temperature of the thermostat, and the like.

Numerous techniques may be employed to perform the actual operation of the private IoT devices 110, i.e., to control those private IoT devices 110, and to receive data, i.e., information from the private and/or public IoT devices 110, 112. In one technique, control of the private IoT device 110 remains with the manufacturer of the private IoT device 110. As such, when the system 100 issues a command to operate the private IoT device 110, a signal S₁₃₀ may be sent from the server 101 to a second server 130 in communication with the network 108. The second server 130 may then operate the private IoT device 110. Likewise, data regarding the operational state of the private IoT device 110 may be sent via another signal S₁₀₁ from the second server 130 to the server 101 and, thus, to user interface devices 114 per the permissions classifications.

In another technique, a separate application may run on a computer (not shown) or other device that operates on the same local area network (not shown) as one or more of the private IoT devices 110 and is in communication with the network 108, and thus, the server 101. In response to receiving a signal to operate the private IoT device 110 from the server 101, this separate application may then control the private IoT devices 110.

Yet another technique communicates with devices via the HomeKit standard provided by Apple, Inc., of Cupertino, Calif. In this technique, commands from the user using the user interface device 114 or server 101 are communicated to the phone's operating system, with the results of the commands recorded back to server 101 to record their effect. The phone's operating system, in turn, communicates the instructions to the private IoT device 110. In yet a further technique, the private IoT device 110 may be directly operated via the network 108. That is, the private IoT device 110 is configured to receive commands directly from either the server 101 or the user interface device 114.

In yet another technique, the user interface device 114 may communicate directly with the private IoT device 110 via Wi-Fi, Bluetooth, or other suitable communication technique. The user interface device 114 may then report on operation of and/or the current state of the private IoT device 110 to the server 101.

As described above, the server 101 is configured to provide the requisite processing, configuration, communications, and control functionality disclosed herein, where the server 101 acts as a central hub. The server 101 incorporates, i.e., collects and stores the APIs of all of the IoT devices 110, 112 and user interface devices 114 connected to the network 108 into a centralized hub. Further, the server 101 may function as a broker between all of the IoT devices 110, 112 and the user interface device(s) 114 to control, monitor, and/or publish updates regarding a status of the various IoT devices 110, 112, via a user account. As will be explained in more detail below, in one embodiment, a user account, running on a corresponding user interface device 114, may be configured to function as a universal remote control for various IoT devices 110, 112. Additionally, as explained in more detail below, the system 100 may also be configured to selectively provide a concierge function that offers suggestions to the user, via the user interface device 114.

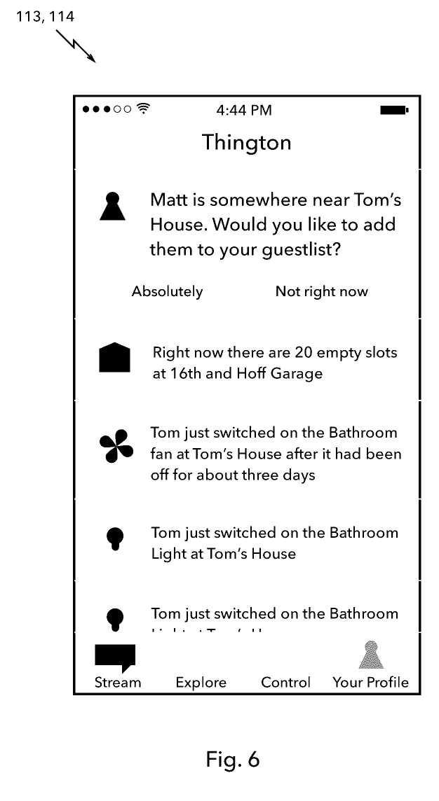

In one exemplary embodiment, the processor 102 is configured to receive the various data received from the IoT devices 110, 112, the second server 130, and/or additional sources of information. The processor 102 and/or the memory 104 maintains a record of the state of the place or the IoT device 110, 112, e.g., which lights are on, who is at the place, what the temperature is, etc. As such, this data may include, but is not limited to, when each private IoT device 110 is operated and the particular user who operated the private IoT device 110. This data may be displayed on the user interface device 114 such that it may be accessed by the user. In the exemplary screen shown in FIG. 5, the data for one particular private IoT device 110 displayed in a chronological order. In another exemplary screen, as shown in FIG. 6, the data for each followed IoT device 110, 112 is displayed in a chronological order. Of course, other techniques for displaying and/or otherwise conveying the data may alternatively be implemented.

In the exemplary embodiments shown in FIGS. 5 and 6, the data is presented in language that is useful and easily readable. For example, as shown in FIG. 6, the event of a light being turned on is described as “Tom just switched on the Bathroom Light at Tom's House” and the current parking garage status is presented as “Right now there are 20 empty slots at 16^{th} and Hoff Garage at 44 Hoff Street.” The reason for the change of state and/or operation of an IoT device 110, 112 may also be conveyed. For example, the user interface device 114 may display that “The porch light turned on due to the time being 30 minutes after sunset” or “John turned on the bathroom light at Tom's House.” As such, the user is presented with information that is relevant and useful in an easily understood format.

In the exemplary embodiment, one or more private IoT devices 110 may be reclassified as public IoT devices 112 by a user having a first permissions classification for the one or more private IoT devices 110. For example, where the private IoT device 110 is a personally-owned weather station (not separately numbered), the weather station may be reclassified as a public IoT device 112, such that anyone may see data provided by the weather station (e.g., temperature, wind speed, humidity, etc.). Of course, the owner of the weather station may reclassify the device at any time.

The user information stored in the memory 104 may include at least one rule regarding operation of one or more of the private IoT devices 110. That is, a rule may associate a location of the user interface device 114 and/or other factors to operation of at least one IoT device. For example, a rule might mandate turning on a light and setting a thermostat to a certain temperature in response to (1) the user interface device 114 entering the place 120 (e.g., arriving at home), (2) it is dark outside (based, e.g., on astronomical data for the place 120), and (3) and no other authorized user interface device 114 is within the place 120 (e.g., no other user is at the location). In another example, the rule may simply set a thermostat to a desired temperature when the user interface device 114 is at a particular location. As another example, a hue light may change color in response to a smoke alarm indicating a fire. As yet another example, a sprinkler system may be inhibited from running unless a nearby weather station indicates that no rain has fallen in 24 hours. Of course, numerous other rules may be stored in the memory 104.

Notably, as described above, the system 100 allows the user to control multiple private IoT devices 110 and/or receive data from a plurality of private or public IoT devices 110, 112. The IoT devices 110, 112 may be produced by one or more manufacturers. As such, the system 100 may be used as a centralized mechanism for control of seemingly disparate devices, over the network 108.

In one embodiment, the system 100 may function as a concierge to the user, where rules are developed with the assistance of the user interface device 114, after the user interface device 114 present at least one question to the user. The question(s) may include a Boolean question, i.e., a question to which the user could answer “yes” or “no”. For example, the system 100 may ask, via the user interface device 114, “When you're the first to get back to My House would you like me to turn on some lights?” The user interface device 114 may then receive a “yes” or “no” answer to the question. In response to a “yes” answer, the system 100 may then present a list of lights and ask, “Which lights would you like me to turn on when you are the first to get back to My House?” The user interface device 114 may then receive a selection of which lights to turn on. The processor 102 then determines at least one rule based on the answer to the question(s) and stores that rule in the memory 104 for future recall. As such, the system 100 may, in the future, utilize that rule in controlling one or more private IoT devices 110.

In another non-limiting example, a user may be asked a series of questions in the user interface device 114, where the questions are formatted as a chat-like conversation. The chat-like conversation is configure to assist in determining a more complex or focused scenario. For example, the system 100 may ask, via the user interface device 114, “Would you like me to turn on some lights when I spot some motion at your house?” The user interface device 114 may then receive a ‘yes’ or ‘no’ answer to the question. In response to a yes answer, the system 100 may be configured to present a list of motion detectors to the user on the user interface device 114, and ask, “Which motion detector would you like me to use”. The use interface device 114 may then receive a selection from the user of the user interface device 114 of a particular motion detector to observe for movement. The system 100 may then ask, “Which lights should I turn on when I observe movement,” resulting in a subsequent input from the user via the user interface device 114, and finally “How long after I turn these lights on should I turn them off again,” presenting the user with a set of options that are displayed on the user interface device 114, such as “10 minutes,” “30 minutes,” or some other arbitrary amount. The processor 102 may be configured to subsequently determines at least one rule that is based on the answer to the questions, and then stores that rule in the memory 104 for future recall. Further, as discussed above, the system 100 may, in the future, utilize that rule to control one or more private IoT devices 110.

A plurality of the above referenced questions may be predeveloped and stored in the memory 104 of the server 101. These questions may selectively presented to the interface device 114 based on the types of public and private IoT devices 110, 112 associated with the user. These questions may also be selectively presented to the user based on the location of the user interface device 114, time of day, day of the week, or any other known information. Of course, the questions may be updated, added, modified, or otherwise changed based on the connectivity of different public and private external 114 devices with the system 100.

The processor 102 is configured to access the various rules described above and is further configured to compare the various data received by the processor 102 to the various rules. When all of the criteria for a particular rule is fulfilled, then the processor 102 is further configured to issue a command to implement the rule per any one of the various control techniques described above.

One or more rules may be associated only with the user and thus may “travel” with the user from one place 120 to another region. For example, if the rule is a 70° F. thermostat setting, and the user is detected at the first place 120, a thermostat associated with the first location is set to 70° F. upon arrival of the user within that place 120. When the first place is unoccupied, e.g., after the user has departed that place 120, the thermostat may then be reset to a different temperature, e.g., to conserve energy. When the user is detected at a second region, the rule may then set the thermostat associated with the second place to 70° F.

As alluded to above, the memory 104 may be utilized to store data regarding the private and public IoT devices 110, 112. For example, temperature and humidity readings from a plurality of thermostats may be stored in the memory 104. The processor 101 may manipulate this data in numerous ways. For example, the processor 102 may average the temperature and humidity readings, and present the reading to the user of the user interface device 114.

The system 100 may be configured to integrate the data and functionality of the various public and private IoT devices 110, 112, regardless of the manufacturer of those devices 110, 112. For example, when a motion sensor detects that a person is standing near the door of a home, the system 100 may then flash, i.e., turn on and off, certain lights in the home to alert a user that someone has arrived at the home, even though the motion sensor and the lights are produced by different manufacturers are were not meant to be operated in concert by those manufacturers. Furthermore, the user need only access one software application on the user interface device 114 in order to receive data from a plurality of different, seemingly disparate devices 110, 112.

The present disclosure has been described herein in an illustrative manner, and it is to be understood that the terminology which has been used is intended to be in the nature of words of description rather than of limitation. Obviously, many modifications and variations of the disclosure are possible in light of the above teachings. The disclosure may be practiced otherwise than as specifically described within the scope of the appended claims.

1. A system comprising:
a processor; and
a memory on which is recorded instructions for translating data received from a plurality of devices in networked communication with a network;
wherein the processor is configured to execute the instructions from the memory and thereby cause the processor to:
establish a network connection with the network;
receive a plurality of data associated with the plurality of devices;
translate the data for each of the plurality of devices into a translated data standard, having a standardized language; and
distribute the translated data, having the standardized language, to at least one of the plurality of devices in networked communication with the network.

2. The system, as set forth in claim 1, wherein the processor is further configured to:
query at least one Internet of things (IOT) device in networked communication with the network; and
receive data from the at least one IOT device.

3. The system, as set forth in claim 2, wherein the processor is further configured to store a current state of each IoT device in the memory.

4. A system for interfacing with at least one external device, the system comprising:
a database configured to store user information and data associated with the at least one external device;
wherein the user information includes a first permissions classification and a second permissions classification;
wherein the data associated with the at least one external device includes location data;
a user interface device in communication with the database and including a location determining element configured to determine a location of the user interface device;
wherein the user interface device provides information regarding the at least one external device based at least on the location of the user interface device;
wherein the user interface device receives input from a user regarding operation of the at least one external device;
a controller in communication with the at least one external device, the database, and the user interface device and configured to control operation of the at least on external device based at least on the permissions classification and the location of the user interface device;
wherein the controller permits operation of the at least one external device in response to the user information having the first permissions classification regardless of the location of the at least one external device;
wherein the controller inhibits operation of the at least one external device in response to the user information having the second permissions classification and the location of the at least one external device being outside a predetermined distance from the at least one external device;
wherein the user information includes at least one rule associating a user and operation of the at least one external device;
wherein the controller operates the at least one external device based on the at least one rule and the location of the user interface device;
wherein the user interface device presents at least one question to the user;
wherein the user interface device receives an answer to the at least one question;
wherein the controller determines at least one rule based on the answer to the at least one question; and
wherein the at least one question is further defined as at least one Boolean question.
